(19) United States
(12) Patent Application Publication
(10) Pub. No.: US 2014/0020843 A1
(43) Pub. Date: Jan. 23, 2014

(54) MACHINE FOR CUTTING OBJECT AND STICKING FILM

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: QIU-SHENG LU, Shenzhen (CN); DONG-YUE WU, Shenzhen (CN); JUN ZHANG, Shenzhen (CN); ZHAO-YONG LI, Shenzhen (CN)

(21) Appl. No.: 13/939,331

(22) Filed: Jul. 11, 2013

(30) Foreign Application Priority Data
Jul. 20, 2012 (CN) 2012102526277

(51) Int. Cl. B32B 38/00

(52) U.S. Cl. CPC B32B 38/0004
USPC 156/512

(57) ABSTRACT

A machine for cutting off a redundant part of a workpiece and affixing film to a top surface of the workpiece includes a stand, a cutting device, and an affixing device. The stand has a work platform. The workpieces slide on the work platform. The cutting device includes a first blade. The film provider dispenses the film. The affixing device has a pressing portion facing the work platform. The workpiece slides to the cutting device and the affixing device. The film is unwound and passes over the pressing portion. The cutting device cuts off the redundant parts of the workpiece when the workpiece slides under the cutting device, and the pressing portion presses the film onto the top surface of the workpiece when the workpiece slides under the affixing device.

### BACKGROUND

1. Technical Field

The present disclosure relates to a machine, particularly to a machine for automatically cutting an object and sticking a film to the object.

2. Description of Related Art

Most plastic pieces always has burrs after being molded. The burrs need to be removed from the plastic piece before the plastic piece can be used. Furthermore, a surface of the plastic piece is always stuck with a film for preventing the plastic piece from being scratched accidently. However, removing the burrs from the plastic piece and sticking the film to the plastic piece are both operated manually, which takes a lot of time for the operators.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a machine for cutting object and sticking film with loaders in accordance with an embodiment. The machine includes a work platform, a cutting device, an affixing device, and an affixing and cutting device.

FIG. 2 is an isometric view of the machine being taken off one of the loaders in FIG. 1.

FIG. 3 is an isometric view of the work platform in FIG. 1.

FIG. 4 is a reverse view of the machine in FIG. 1.

FIG. 5 is an isometric view of the machine in FIG. 4 viewed from another aspect.

FIG. 6 is a view of the machine being taken off the cutting device in FIG. 1.

FIG. 7 is a reserve view of the cutting device in FIG. 6.

FIG. 8 is a view of the film affixing apparatus being taken off the affixing device and the affixing and cutting device in FIG. 1 viewed from another aspect.

FIG. 9 is a reverse view of the affixing device in FIG. 8.

FIG. 10 is a reverse view of the affixing and cutting device in FIG. 8.

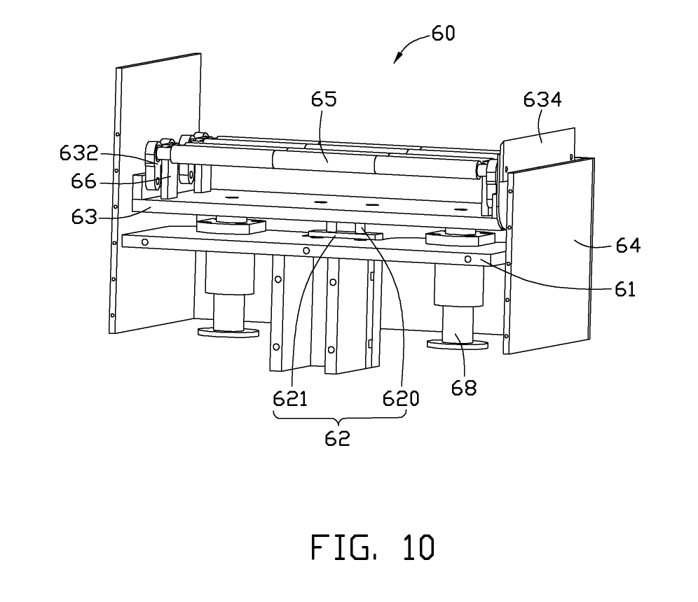

FIG. 11 is an isometric view of the affixing and cutting device in FIG. 8 viewed from another aspect.

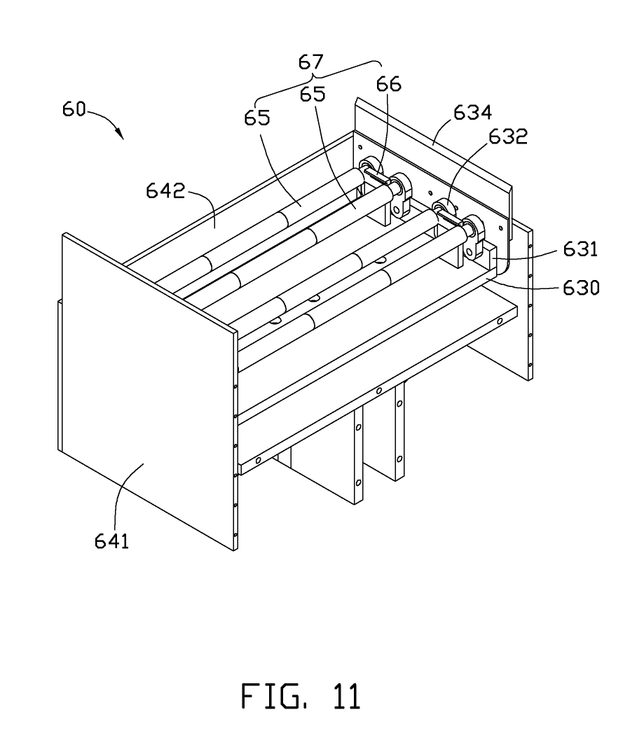

### DETAILED DESCRIPTION

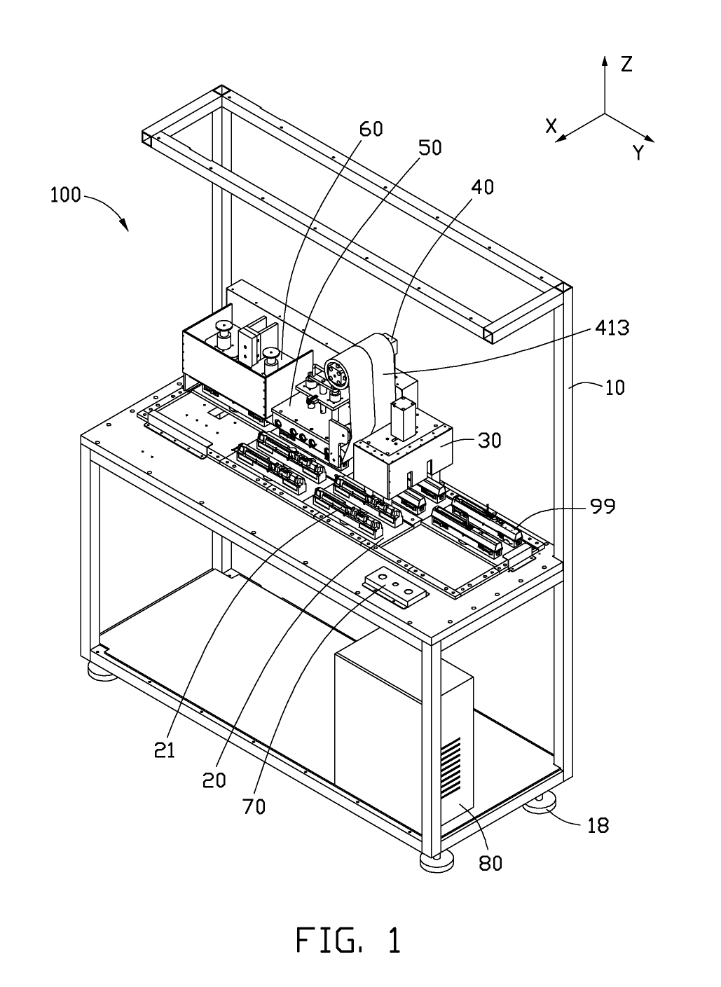

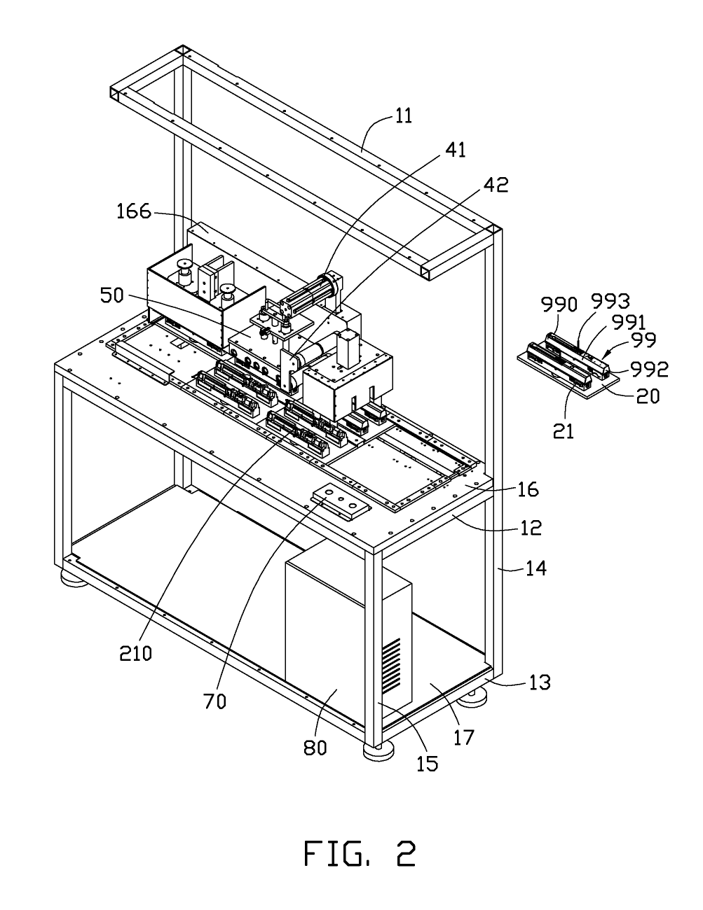

FIGS. 1 and 2 show an embodiment of a machine 100 for cutting object and sticking film. The machine 100 cuts workpieces 99 and sticks a film to the workpieces 99. Each workpiece 99 includes a rectangular top surface 990, two parallel first sidewalls 991, and two parallel second sidewalls 992. A redundant part 993 protrudes from the top surface 990. The first sidewalls 991 and the second sidewalls 992 extend from the top surface 990 and encircle the top surface 990. The top surface 990, the first surface 991, and the second surface 992 are required to be covered with film. The redundant parts 993 need to be cut off from the workpieces 99. In the embodiment, the workpieces 99 are plastic pieces, and the redundant parts 993 of the workpieces 99 are burrs.

The machine 100 includes a stand 10, loaders 20, a cutting device 30, a film provider 40, an affixing device 50, an affixing and cutting device 60, an operating box 70, and a control box 80. The cutting device 30, the film provider 40, the affixing device 50, the affixing and cutting device 60, the operating box 70, and the control box 80 are mounted to the stand 10.

Each loader 20 includes two positioning parts 21 which are not attached to each other. Each positioning part 21 is used to position one workpiece 99. Each positioning part 21 defines a first through hole 210.

The stand 10 includes a top frame 11, a work frame 12, a holding frame 13, two first legs 14, two second legs 15, a work platform 16, a holding platform 17, and four supporting stands 18. The top frame 11, the work frame 12, and the holding frame 13 are parallel, and the work frame 12 is located between the top frame 11 and the holding frame 13. A size of the work frame 12 is the same as a size of the holding frame 13, but is different from a size of the top work frame. A width of the top frame 11 is less than a width of the work frame 12. The two first legs 14 are both connected to the top frame 11, the work frame 12, and the holding frame 13, and are arranged at the same side of the top frame 11, the work frame 12, and the holding frame 13. The two second legs 15 are both fixed to the work frame 12 and the holding frame 13, and are arranged at the same side opposite to the two first legs 14. The four supporting legs 18 are arranged on the holding frame 13 and opposite to the work frame 12 to make the stand 10 stand-off above the floor. The holding platform 17 is rectangular and placed on the holding frame 13. The work platform 16 is rectangular and placed on the work frame 12.

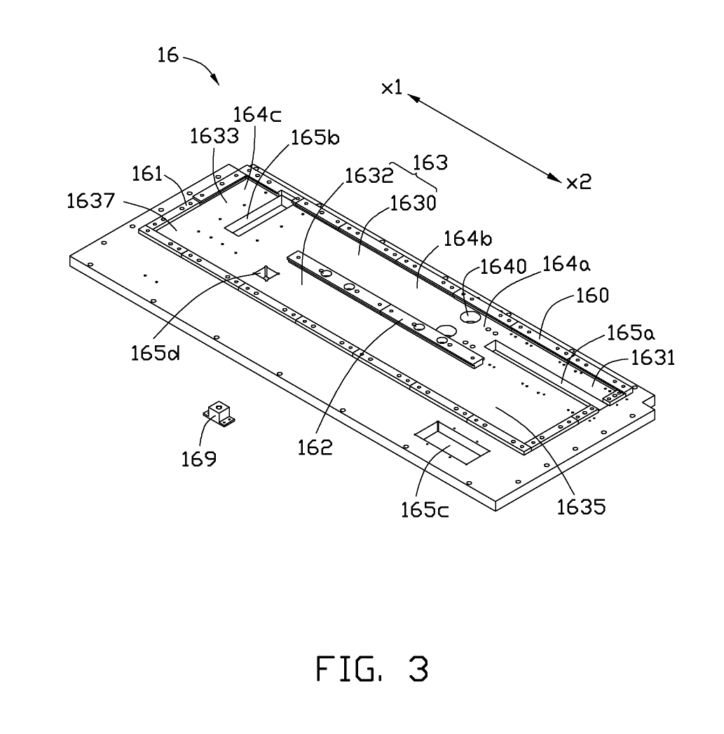

FIG. 3 shows an embodiment of the work platform 16. Two first blocking bars 160, two second blocking bars 161, and a third blocking bar 162 are arranged on one surface of the work platform 20 away from the holding platform 17. The first blocking bars 160 are parallel to each other. The second blocking bars 161 are parallel to each other and are connected between the first blocking bars 160. The second blocking bars 161 and the first blocking bars 160 cooperatively define a rectangular work region 163. The third blocking bar 162 is positioned in the middle of the work region 163 and is parallel to the first blocking bars 160. The third blocking bar 162 is shorter than the first blocking bars 160, such that opposite distal ends of the third blocking bar 162 are separated from the two second blocking bars 161. The third blocking bar 162 divides the work region 163 into an operating region 1630 and a waiting region 1632 for receiving the loaders 20, and the operating region 1630 is on one side of work platform 16 which is fixed to the first legs 14. The operating region 1630 and the waiting region 1632 are symmetrical with respect to the third blocking bar 162. The operating region 1630 is capable of receiving four loaders 20. The operating region 1630 includes a first end 1631 and a second end 1633 opposite to the first end 1631. The waiting region 1632 includes a third end 1635 and a fourth end 1637 opposite to the third end 1635. The first end 1631 and the third end 1635 communicate with each other, and each receive one loader 20. The second end 1633 and the fourth end 1637 communicate with each other, and each receive one loader 20.

The work platform 16 has a first work station 164a, a second work station 164b, a third work station 164c, and a mounting part 166. The work platform 16 defines a first opening 165a, a second opening 165b, a third opening 165c, and a fourth opening 165d. The first work station 164a, the second work station 164b, and the third work station 164c are on the operating region 1630, and each receives one loader 20. The first work station 164a communicates with the second work station 164b, and the second work station 164b communicates with the third work station 164c. The first work station 164a is in the first end 1631 and defines two second through holes 1640. The third work station 164c is in the second end 1633. The first opening 165a is substantially rectangular and is defined in the first end 1631 parallel to the first blocking bars 160. The second opening 165b is substantially rectangular and is defined in the third work station 164c parallel to the second bars 161. The third opening 165c is adjacent to one side of the waiting region 1632 away from the operating region 1630. The fourth opening 165d is defined in the fourth end 1637. The mounting part 166 is a substantially rectangular board and protrudes from one side of the first work station 164a adjacent to the operating region 1630. An end of the mounting part 166 is adjacent to an end of the first work station 164a adjacent to the first end 1631, and an opposite end of the mounting part 166 is adjacent to an end of the third work station 164c away from first end 1631.

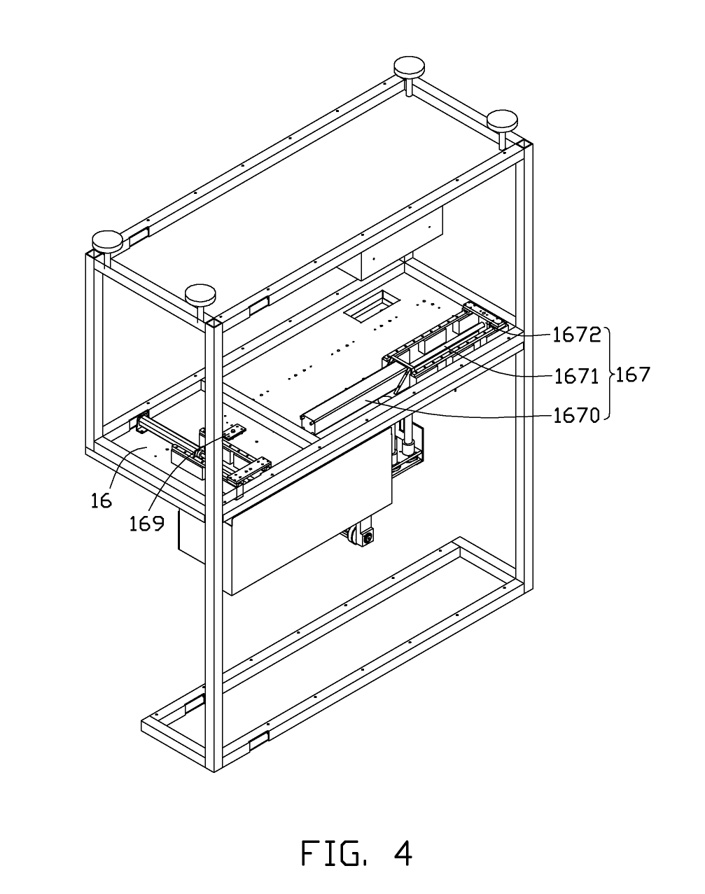

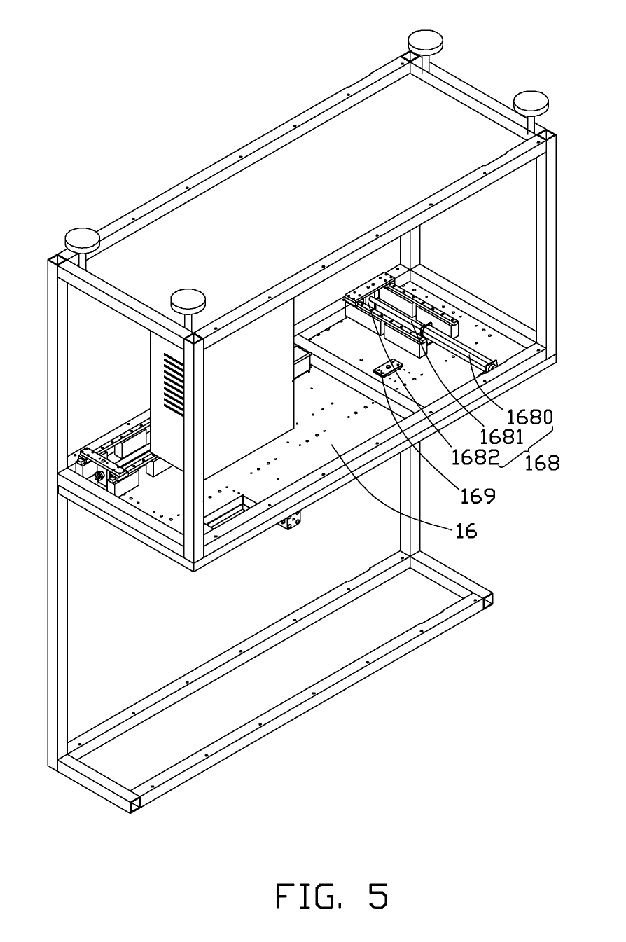

Referring to FIGS. 4 and 5, a first driving device 167, a second driving device 168, and a sensor 169 are further set on the work platform 16. The first driving device 167 and the second driving device 168 are arranged on the other surface of the work platform 16 opposite to the first blocking bars 160. The first driving device 167 drives the loaders 20 to move in a first direction X (see FIG. 1) parallel to the first blocking bars 160. The second driving device 168 drives the loaders 20 to move in a second direction Y (see FIG. 1) parallel to the second blocking bars 161.

The first driving device 167 includes a first driving body 1670, a first driving arm 1671, and a first driving block 1672. The first driving body 1670 is adjacent to the first opening 165a, and the first driving arm 1671 extends along a length of the first opening 165a. The first driving block 1672 is received in the first opening 165a. The first driving block 1672 is secured on an end of the first driving arm 1671 away from the first driving body 1670. The first driving body 1670 drives the first driving arm 1671 to move from one end of the first opening 165a to an opposite end of first opening 165a, causing the driving block 1672 to move along the first direction X towards and away from the second end 1633. In its original state, the first driving block 1672 is positioned at a side of the first end 1631 away from the second end 1633, such that the first driving block 1672 abuts against a side of the loader 20 away from the second end 1633. The driving block 1672 pushes the loader 20 towards the second end 1633 as the first driving arm 1671 is caused to move along the first direction X towards the second end 1633.

The second driving device 168 includes a second driving body 1680, a second driving arm 1681, and a second driving block 1682. The second driving body 1680 is adjacent to the second opening 165b. The second driving arm 1681 is connected to the second driving body 1680 and extends along the length of the second opening 165b. The second driving block 1682 is fixed on an end of the second driving arm 1681 away from the second driving body 1680 and is received in the second opening 165b. The second driving body 1680 drives the second driving arm 1681 to move along the second direction Y, causing the second driving block 1682 to move along the second direction Y along with the second driving arm 1681 towards and away from the fourth end 1637. In its original state, the second driving block 1682 is positioned at a side of the second end 1633 away from the fourth end 1637. The second driving block 1682 abuts a side of the loader 20 away from the fourth end 1637 so that the driving block 1682 pushes the loader 20 toward the fourth end 1637 when the second driving arm is caused to move along the second direction Y toward the fourth end 1637. In this way, the first driving device 167 and the second driving device 168 cooperatively drive the workpieces 99 loaded on the loaders 20 to loop around the work region 163.

The sensor 169 is located in the fourth opening 165d for detecting whether or not a loader 20 or another object is positioned in the fourth end 1637.

Referring to FIGS. 1 and 2 again, the cutting device 30, the film provider 40, the affixing device 50, and the affixing and cutting device 60 are mounted to the work platform 16 and above the operating region 1630. The cutting device 30 faces the first work station 164a, the affixing device 50 faces the second work station 164b, and the affixing and cutting device 60 faces the third work station 164c.

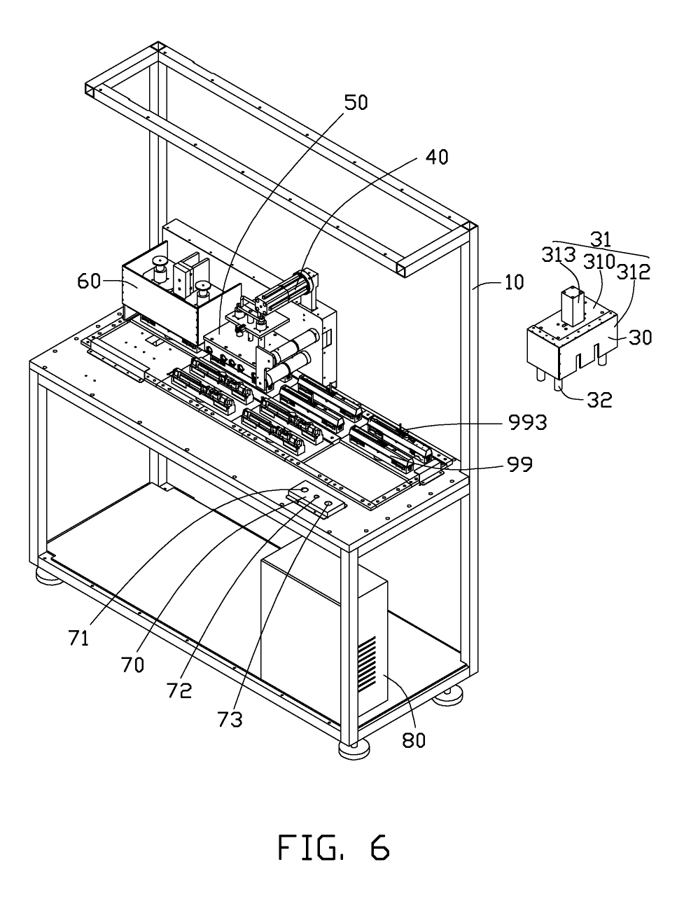

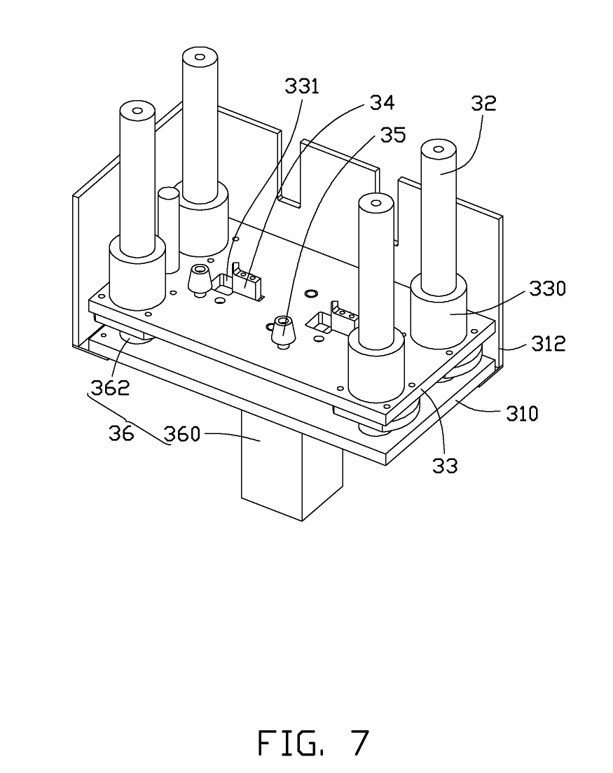

Referring to FIGS. 6 and 7, the cutting device 30 includes a housing 31, four fixing members 32, a movable member 33, two blades 34, two pressing members 35, and a third driving device 36. The movable member 33 is movably sleeved on the four fixing members 32. The two blades 34 and the two pressing members 35 are fixed on the movable member 33. The third driving device 36 is mounted to the housing 31 to drive the movable member 33 to slide along the fixing members 32.

The housing 31 includes a top portion 310, a lateral board 312, and a receiving part 313. The top portion 310 is substantially rectangular. The lateral board 312 protrudes downwards from the top portion 310 and is arranged on two adjacent sides of the top portion 310. The receiving part 313 is substantially hollow and protrudes upwards from a middle of the top portion 310.

The four fixing members 32 protrude downwards from four corners of the top portion 310 and are secured to the work platform 16. Two fixing members 32 are secured to the third blocking bar 162, and the other two fixing members 32 are secured to the first blocking bar 160.

The movable member 33 is substantially rectangular. Four sleeves 330 protrude from corners of the movable member 33. The four sleeves 330 each sleeve a fixing member 32. Two third through holes 331 corresponding to the second through holes 1640 are defined in the movable member 33.

The third driving device 36 includes a third driving body 360 and four third driving arms 362 fixed to the third driving body 360. The third driving body 360 is received in the first receiving part 313. The movable member 33 is fixed to ends of the third driving arms 362 away from the third driving body 360. The third driving body 360 drives the third driving arms 362 to move away from and towards the third driving body 360 along a third direction Z (see FIG. 1) parallel to the fixing member 32, causing the movable member 33 to move away from and towards the top portion 310.

The two first blades 34 and the two pressing members 35 are secured to a side of the movable member 33 away from the top portion 310. Each first blade 34 is adjacent to a pressing member 35. The two first blades 34 and the two pressing members 35 move away from and towards the top portion 310 when the movable member 33 moves. In its original state, the movable member 33 is adjacent to the top portion 310.

Referring to FIGS. 1, 2 and 6 again, the film provider 40 and the affixing device 50 are arranged over the operating region 1630 and face the first work station 164a. The affixing device 50 is adjacent to the film provider 40 and is away from the first end 1631. The film provider 40 includes a hanging member 41 and a stretching member 42. The hanging member 41 includes a supporting element 410 and a hanging element 412. The supporting element 410 protrudes upwards from a side of the mounting part 166 away from the platform 16. The hanging element 412 is cuboid and extends substantially perpendicularly from an end of the supporting element 410 away from the mounting part 166. Four ribs 4120 protrude from four side surfaces of the hanging element 412. Three tabs 4121 protrude from opposite ends and the middle of each rib 4120, so as to divide the hanging element 412 into a first hanging portion 4122 and a second hanging portion 4123. The first hanging portion 4122 and the second hanging portion 4123 are each sleeved by a roll of film 413, which unwinds straight down.

The stretching member 42 includes a first stretching element 420, a second stretching element 421, and a connecting element 423. The first stretching element 420 and the second stretching element 421 are substantially columnar and are substantially the same. The first stretching element 420 and the second stretching element 421 substantially perpendicularly project from a side of the mounting part 166 and are parallel to the hanging element 412. The first stretching element 420 is positioned between the second stretching element 421 and the hanging element 412. The middle of the first stretching element 420 defines a groove 4201, and the middle of the second stretching element 421 defines a groove 4211. The connecting element 423 includes a first rectangular base 4230 and a second rectangular base 4231 that extends from an end of the first rectangular base 4230. The second rectangular base 4231 is fixed to an end of the first stretching element 420 away from the mounting part 166. The second rectangular base 4231 is fixed to an end of the second stretching element 421 away from the mounting part 166. The two rolls of the films 413 spread over and cover the first stretching element 420 and the second stretching element 421 and wind around the affixing device 50, such that the film 413 is tightened via the first stretching element 420 and the second stretching element 421. Furthermore, the two rolls of the films 423 are separated from each other via the grooves 4201 and 4211.

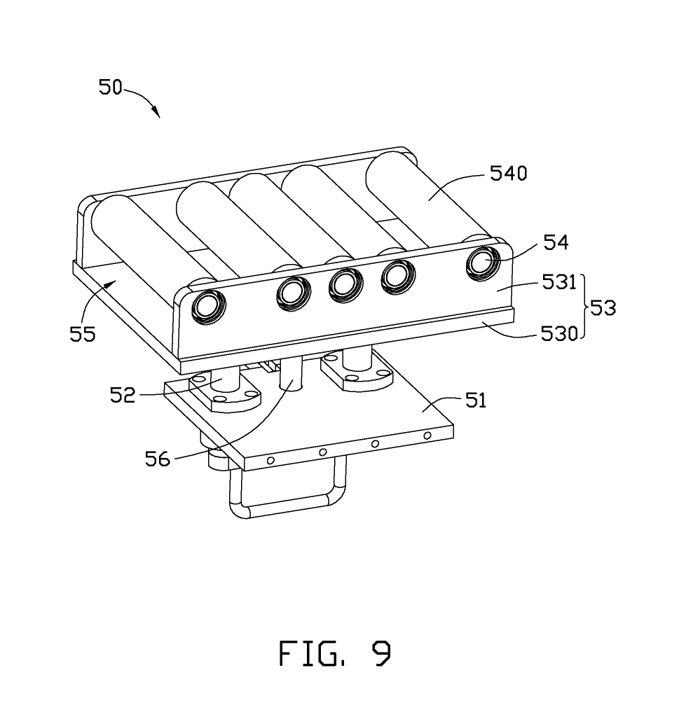

Referring to FIG. 9, the affixing device 50 includes a fixing board 51, two first connecting poles 52, a second connecting pole 56, a mounting case 53, and five first rollers 54. The fixing board 51 is parallel to the work platform 16, and a side of the fixing board 51 is substantially rectangular and is fastened to the mounting part 166. The fixing board 51 faces the first work station 164a. An end of the first connecting poles 52 and the second connecting pole 56 is mounted to the fixing board 51, while the other end of the first connecting poles 52 and the second connecting pole 56 is mounted to the mounting case 53. The first connecting poles 52 and the second connecting pole 56 are substantially columnar, and a diameter of a first connecting pole 52 is less than a diameter of the second connecting pole 56. The first connecting poles 52 and the second connecting pole 56 are arranged collinearly, and the first connecting poles 52 are symmetrically arranged on two sides of the second connecting pole 56. The mounting case 53 includes a top portion 530 and two side boards 531 extending from two opposite sides of the top portion 530. The two side boards 531 are substantially parallel to the mounting part 166. A side of the top portion 530 is connected to the first connecting poles 52 and the second connecting pole 56, and the second connecting pole 56 is positioned in the middle of the top portion 530 to balance the mounting case 53. The first rollers 54 are columnar and are substantially the same size. Each first roller 54 is rotatably connected between the side boards 531, and each first roller 54 is substantially perpendicular to the mounting board 166. The five first rollers 54 are arranged on a plane to form a pressing portion 540, which rises above the side boards 531 and is substantially parallel to the work platform 16. The pressing portion 540 faces the first work station 164a. The loaders 20 loading the workpieces 99 pass one by one under the first rollers 54, such that the pressing portion 540 presses the top surfaces 990.

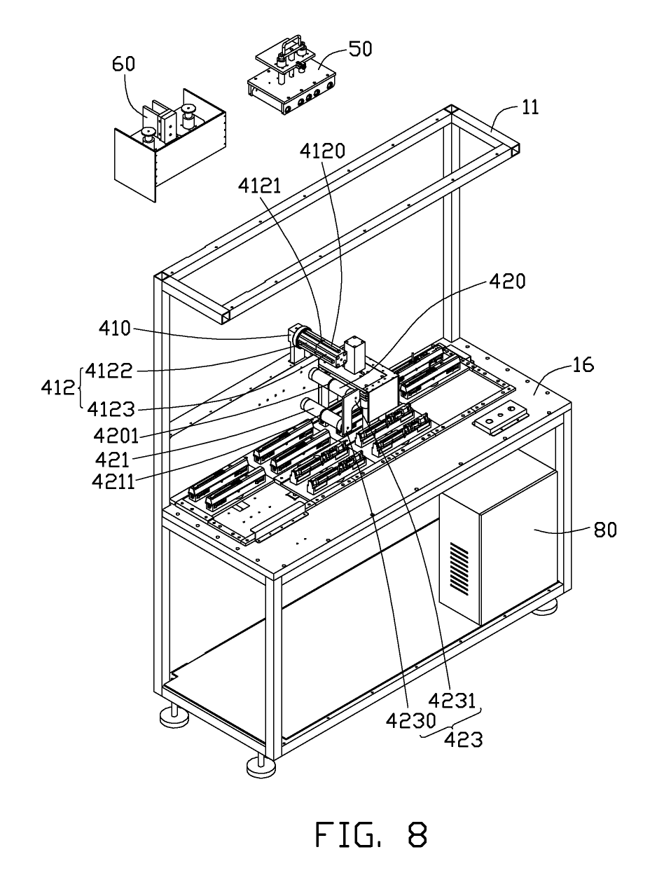

Referring to FIGS. 8 and 9, the affixing and cutting device 60 includes a securing board 61, a fourth driving device 62, two parallel third connecting poles 68, an installing part 63, a blocking casing 64, and four second rollers 65.

The blocking casing 64 includes two first parallel blocking boards 641 and a second blocking board 642 connected between the first blocking boards 641. The first blocking boards 641 are secured on the mounting part 166 via screws (not shown), and one of the first blocking boards 641 is adjacent to the affixing device 50. The second blocking board 642 is substantially parallel to the mounting part 166. The securing board 61 is substantially rectangular and is substantially parallel to the work platform 16. Two ends of the securing board 61 are fastened to a middle of the two first blocking boards 641 correspondingly, and a side of the securing board 61 is fastened to the mounting part 166.

The fourth driving device 62 includes a fourth driving body 620 and a fourth driving arm 621 connected to the fourth driving body 620. The fourth driving body 620 is mounted to a side of the securing board 61 away from the work platform 16. The fourth driving arm 621 extends through the securing board 61 to connect to the installing part 63. The third connecting poles 68 extend through the securing board 61 and connect to the installing part 63. The third connecting poles 68 are symmetrically positioned at opposite sides of the driving arm 621.

The installing part 63 includes a substantially rectangular first base board 630 parallel to the securing board 61, and two parallel second base boards 631 substantially perpendicularly extending from the first base board 630. The first base board 630 is connected to the fourth driving arm 621 and the third connecting poles 68, and the driving arm 621 is connected to the middle of the base board 630. From each second base board 631 projects four bearings 632. The bearings 632 on one second base board 631 correspond to the bearings 632 on the other second base board 631. The bearings 632 on each second base board 631 are divided into two pairs. Gaps between each pair of the bearings 632 are identical. There is a pressing block 66 protruding between each pair of the bearings 632. The second base board 631 adjacent to the affixing device 50 has a second blade 634 extending toward the work platform 16.

The four second rollers 65 are columnar and identical. Two ends of each second roller 65 extend to the two second base boards 631 and connect to two corresponding bearings 632, such that the four second roller 65 are also divided into two pairs. Axes of the four second roller 65 are substantially parallel to the mounting part 166 and substantially perpendicular to the axes of the first rollers 54. Each pair of the second rollers 65 and each pressing block 66 cooperatively form one hollow pressing part 67. A distance between each pair of pressing blocks 66 is the same as a distance between the two second sidewalls 992 of each workpiece 99, and a distance between each pair of second rollers 65 is the same as a distance between the two first sidewalls 991. Each pressing part 67 receives one workpiece 99. The first sidewalls 991 abut the two second rollers 65, and the second sidewalls 992 abut the two pressing blocks 66. The installing part 63 moves along with the fourth driving arm 621, causing the pressing parts 67 to move towards and away from the platform 16. In its original state, the installing part 63 is away from the work platform 16.

The control box 80 is arranged on the holding member 17 for controlling the first driving device 167 and the second driving device 168 to enable the affixing device 50 to affix film 143 to the workpiece 99. The control box 80 pauses when the sensor 169 detects an object.

The operating box 70 is secured in the third opening 165c to control the control box 80. The control box 70 includes a start button 71, a stop button 72, and an indicator 73. The start button 71 is pressed to start the control box 80. The stop button 72 is pressed to stop the control box 80. The indicator 73 informs the operator if the machine 100 is abnormal, allowing the operator to stop the control box 80 by pressing the stop button 72 or placing an object in the fourth end 1637.

In operation, the waiting region 1632 is fully filled with the loaders 20, and each loader 20 loads two workpieces 99. There is no loader 20 positioned in the operating region 1630. The film 413 spreads over the first stretching element 420 and the second stretching element 421 in a fourth direction x1 (see FIG. 3) parallel to the first direction X, then spreads over in a fifth direction x2 opposite to the fourth direction x1 to locate between the second stretching element 421 and the work platform 16, then passes out of the affixing and cutting device 60 along the fifth direction x2. Next, a first loader 20 positioned at the third end 1635 is pulled to the first end 1631. The start button 71 is pressed, and the control box 80 controls the first driving body 1670 to drive the first driving arm 1671 to move a predetermined first distance which is equal to the length of the loader 20 along the fourth direction x1, causing the first driving block 1672 to push the first loader 20 to the first work station 164a. At this point, the first through hole 210, the second through hole 1640, and the third through hole 331 are concentric. Then the control box 80 controls the first driving arm 1671 to return to its original state. Next, the control box 80 controls the third driving body 360 to drive the third driving arm 362 to move a second predetermined distance along the third direction Z towards the work platform 16, causing the pressing members 35 to press the workpieces 99 loaded on the first loader 20, and the first blades 34 cut off the redundant parts 993. Then the control box 80 controls the third driving arm 362 to return to its original state. Next, a second loader 20 is pulled from the waiting region 1632 via the third end 1635 to the first end 1631, the start button 71 is pressed, and the control box 80 controls the first driving block 1672 to move the first predetermined distance so as to push the second loader 20, which pushes the first loader 20 into the second work station 164b and under the film 413. The pressing portion 540 presses the film 413 onto the top surfaces 990 of the two workpieces 99 loaded on the first loader 20, and the film 413 is affixed to the top surfaces 990. Next, a third loader 20 is pulled from the waiting region 163 via the third end 1635 to the first end 1631, the start button 71 is pressed, and the control box 80 controls the first driving block 1672 to move the first predetermined distance so as to push the third loader 20 to the first work station 164a. The third loader 20 pushes the second loader 20 into the second work station 164b to have the film 413 affixed on the top surfaces 990 of the workpieces 99 as described above. The second loader 20 pushes the first loader 20 into the third work station 164c and under the film 413. Then the control box 80 controls the third driving arm 362 to move the second predetermined distance to enable the first blades 34 to cut off the redundant parts 993 of the workpieces 99 loaded on the third loader 20, and the control box 80 controls the fourth driving body 620 to drive the driving arm 621 to extend a third predetermined distance to push the pressing part 67 towards the work platform 16, causing the second rollers 65 and each pair of the pressing blocks 66 to press the film 143 to the first sidewalls 991 and the second sidewalls 992 of each workpiece 99 loaded on the first loader 20. The film 413 is cut when the second blade 634 contacts the work platform 16, and the control box 80 controls the third driving arm 362 and the fourth driving arm 621 to return to their original states. This process is repeated until the first loader 20 is positioned in the second end 1633. At this point, the control box 80 controls the second driving body 1680 to drive the second driving arm 1681 to push the first loader 20 a fourth predetermined distance along the second direction Y into the fourth end 1637, allowing the first loader 20 to be easily removed manually from the work platform 16, ending the process for the first loader 20. Then the control box 80 controls the second driving arm 1681 to return to its original state. The workpieces 99 loaded onto the subsequent loaders 20 have their redundant parts 993 cut off and are affixed with the film 413 according to the above operations.

As described above, the process that the machine 100 uses to automatically cut off the redundant parts 993 of the workpieces 99 and affix the film 413 to the workpieces 99 is more convenient than the manual method. Furthermore, the machine 100 can cut off the redundant parts 993 and affix the film 413 to two workpieces 99 at a time, which improves the efficiency of affixing film 413 to the workpieces 99.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A machine for cutting and sticking film, the machine cutting a redundant part of a workpiece and affixing the film to a top surface of the workpiece, the machine comprising:
a stand having a work platform, the workpiece sliding on the work platform;
a cutting device having a first blade moving with respect to the work platform;
a film provider to dispense the film; and
an affixing device having a pressing portion facing the work platform;
wherein the workpiece slides to the cutting device and the affixing device, the film is unwound and passes over the pressing portion, the first blade cuts the redundant part of the workpiece when the workpiece slides to the cutting device, the pressing portion presses the film onto the top surface of the workpiece when the workpiece slides to the affixing device.

2. The machine of claim 1, wherein the cutting device comprises a housing, at least one fixing member, a moveable board, and a driving device, an end of the fixing member is secured to the housing, the other end of the fixing member is secured to the work platform, the moveable board is slideably mounted to the fixing member, the driving device drives the moveable board to slide along the fixing member, the first blade is secured to the moveable board.

3. The machine of claim 1, wherein the affixing device comprises a fixing board and a mounting case, the fixing board is secured to the work platform, the mounting case is secured to the fixing board, the pressing portion is secured to the mounting case and protrudes out of the mounting case to press on the top surface of the workpiece.

4. The machine of claim 1, wherein the pressing portion comprises a plurality of first rollers, the rollers are arranged on a plane.

5. The machine of claim 1, further comprising an affixing and cutting device, the affixing and cutting device comprising a pressing part moving with respect to the work platform, the film being pass over the pressing part, the workpiece sliding to the affixing and cutting device after the top surface of the workpiece is affixed with the film, the pressing part receiving the workpiece and resisting against a sidewall of the workpiece which extends from the top portion so as to press the film onto the sidewall of the workpiece.

6. The machine of claim 5, wherein the affixing and cutting device further comprises a securing board mounted to the work platform, an installing part moveably secured on the securing board, and a driving device; the pressing part is mounted to the installing part; the driving device drives the first installing part to move a first predetermined distance that the workpiece passes through the pressing part and the sidewall of the workpiece resists against the pressing part to affix the film.

7. The machine of claim 5, wherein the affixing and cutting device further comprises a second blade, the second blade cuts off the film affixed on the workpiece from the film provider when the blade contact the work platform.

8. The machine of claim 5, wherein the sidewall of the workpiece comprises two opposite first sidewalls, and two opposite second sidewalls, each of the first sidewalls is connected between the second sidewalls, the pressing part comprises at least one pair of second rollers and at least one pair of pressing blocks, the pressing blocks are between the second rollers and separated from each other, the second rollers presses on the first sidewalls, and the pressing blocks presses the second sidewalls.

9. A machine for cutting and sticking film, the machine cutting a redundant part of a workpiece and affixing a film to a top surface of the workpiece, the machine comprising:
a stand having a work platform, the workpiece being slidably on the work platform;
a cutting device having a first blade moving with respect to the work platform;
a film provider to dispense the film; and
an affixing device having a pressing portion facing the work platform;
wherein the cutting device, the film provider, and the affixing device are arrange serially the film is unwound and passes over the pressing portion, the first blade cuts the redundant part of the workpiece when the workpiece slides to the cutting device, the pressing portion presses the film onto the top surface of the workpiece when the workpiece slides to the affixing device.

10. The machine of claim 9, wherein the cutting device comprises a housing, at least one fixing member, a moveable board, and a driving device, an end of the fixing member is secured to the housing, an opposite end of the fixing member is secured to the work platform, the moveable board is slideably mounted to the fixing member, the driving device drives the moveable board to slide along the fixing member, the first blade is secured to the moveable board.

11. The machine of claim 9, wherein the affixing device comprises a fixing board and a mounting case, the fixing board is secured to the work platform, the mounting case is secured to the fixing board, the pressing portion is secured to the mounting case and protrudes out of the mounting case to press on the top surface of the workpiece.

12. The machine of claim 9, wherein the pressing portion comprises a plurality of first rollers, the first rollers are arranged on a plane.

13. The machine of claim 9, further comprising an affixing and cutting device, the affixing and cutting device comprising a pressing part moving with respect to the work platform, the film being pass over the pressing part, the workpiece sliding to the affixing and cutting device after the top surface of the workpiece is affixed with the film, the pressing part receiving the workpiece, and the pressing part resists against a sidewall of the workpiece which extends from the top portion so as to press the film onto the sidewall of the workpiece.

14. The machine of claim 13, wherein the affixing and cutting device further comprises a securing board mounted to the work platform, an installing part is moveably secured on the securing board, and a driving device; the pressing part is mounted to the installing part; the driving device drives the installing part to move a first predetermined distance that the workpiece passes through the pressing part and the sidewall of the workpiece resists the pressing part to affix the film.

15. The machine of claim 13, wherein the affixing and cutting device further comprises a second blade, the second blade cuts off the film affixed on the workpiece from the film provider when the blade contact the work platform.

16. The machine of claim 13, wherein the sidewall of the workpiece comprises two opposite first sidewalls, and two opposite second sidewalls, each of the first sidewalls is connected between the second sidewalls, the pressing part comprises at least one pair of second rollers and at least one pair of pressing blocks, the pressing blocks are between the second rollers and separates from each other, the second rollers presses on the first sidewalls, and the pressing blocks presses the second sidewalls.
